(19) United States
(12) Patent Application Publication
(10) Pub. No.: US 2025/0171661 A1
(43) Pub. Date: May 29, 2025

(54) MICROPATTERNED SILK-DOPAMINE ADHESIVES COMPOSITE

(71) Applicant: Trustees of Tufts College, Medford, MA (US)

(72) Inventors: Fiorenzo G. Omenetto, Lexington, MA (US); Marco Lo Presti, Arlington, MA (US)

(21) Appl. No.: 18/966,464

(22) Filed: Dec. 3, 2024

Related U.S. Application Data
(63) Continuation of application No. PCT/US23/67922, filed on Jun. 5, 2023.
(60) Provisional application No. 63/348,960, filed on Jun. 3, 2022.
(60) Provisional application No. 63/476,621, filed on Dec. 21, 2022.

(51) Int. Cl. C09J 7/38; B29C 39/00; B29C 39/02; B29C 39/26; B29L 7/00; C09J 5/00

(52) U.S. Cl. CPC C09J 7/38; B29C 39/003; B29C 39/026; C09J 5/00; B29C 39/26; B29K 2089/00; B29K 2883/00; B29L 2007/001; C09J 2301/204; C09J 2301/31

(57) ABSTRACT

A gecko-inspired dry adhesive can include a gecko-mimicking surface pattern affixed to a substrate. The gecko-mimicking surface pattern is composed of a surface material including a polydopamine-substituted silk fibroin.

### CROSS-REFERENCE TO RELATED APPLICATION

This application is a continuation of PCT International Application Serial Number PCT/US2023/067922 (Attorney Docket No. 2095.0542), filed on Jun. 5, 2023, and published as WO2023/235890. PCT International Application Serial Number PCT/US2023/067922 is related to and claims priority to U.S. Provisional Pat. App. No. 63/348,960 (Attorney Docket No. 2095.0407), filed Jun. 3, 2022; and U.S. Provisional Pat. App. No. 63/476,621 (Attorney Docket No. 2095.0408), filed Dec. 21, 2022. Each of the aforementioned patent applications are incorporated herein by reference in their entireties for all purposes.

### STATEMENT REGARDING FEDERALLY SPONSORED RESEARCH

This invention was made with government support under grant N00014-19-1-2399 awarded by the United States Navy. The government has certain rights in the invention.

### BACKGROUND

A dry adhesive is a substance used to adhere two objects without the addition of water or use of other liquid substances. Dry adhesives do not require liquid components in contrast with water-based glues, epoxies, or the like. Typically, dry adhesives are applied on a substrate as a thin layer or film. Dry adhesives can have a pressure-sensitive adhesive response and can be in the form of flexible slabs or strips applied to a surface, sometimes with stretching or deforming. In other examples, dry adhesives can be applied to a carrier and covered with a protective cover that can be removed when the adhesive is needed.

Some dry adhesives have sticky properties based on microscopic protrusions that can be likened to the hairs, or setae, found on the bottom of gecko feet. These setae allow geckos to run up walls or hang from horizontal surfaces, even smooth surfaces like glass. The setae serve to increase the contact surface area between the gecko feet and the surface. Furthermore, van der Waals forces, or intermolecular electrostatic forces, further increase the adhesion between the gecko feet and the surface.

Many dry adhesives, although having a solid form, may include a solvent to retain adhesive properties and pliability. Solvents can evaporate over time reducing the shelf-life of such dry adhesives. Thus, there remains a need for solid-state adhesives that are solvent-free and have a long shelf life.

### SUMMARY

In one aspect, the present disclosure provides a gecko-inspired dry adhesive. The adhesive includes a gecko-mimicking surface pattern affixed to a substrate. The gecko-mimicking surface pattern is composed of a surface material. The surface material includes a polydopamine-substituted silk fibroin.

In another aspect, the present disclosure provides a method of making a gecko-inspired dry adhesive. The method includes forming a gecko-mimicking surface pattern affixed to a substrate. The gecko-mimicking surface pattern includes a polydopamine-substituted silk fibroin. The forming results in the gecko-inspired dry adhesive.

In a further aspect, the present disclosure provides a method of using the gecko-inspired dry adhesive disclosed herein. The method includes contacting an article with the gecko-mimicking surface pattern, thereby adhering the substrate to the article.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention.

FIG. 1. SEM micrograph of a micropatterned polydopamine-silk fibroin (PDA-SF) glycerol film. The inset shows a macroscopic photograph of light diffraction caused by the micropatterning.

FIG. 2. Lap shear results of uncured PDA-SF-glycerol films. The mass ratio of glycerol PDA-SF ranges between 0.1 and 0.7. The results for “0.3 gecko” correspond to the adhesion performance of a micropatterned film of PDA-SF-glycerol where the mass ratio of glycerol:PDA-SF is 0.3.

### DETAILED DESCRIPTION

Before the present invention is described in further detail, it is to be understood that the invention is not limited to the particular embodiments described. It is also understood that the terminology used herein is for the purpose of describing particular embodiments only, and is not intended to be limiting. The scope of the present invention will be limited only by the claims. As used herein, the singular forms “a”, “an”, and “the” include plural embodiments unless the context clearly dictates otherwise.

Specific structures, devices, and methods relating to surface patterning are disclosed. It should be apparent to those skilled in the art that many additional modifications beside those already described are possible without departing from the inventive concepts. In interpreting this disclosure, all terms should be interpreted in the broadest possible manner consistent with the context. Variations of the term “comprising” should be interpreted as referring to elements, components, or steps in a non-exclusive manner, so the referenced elements, components, or steps may be combined with other elements, components, or steps that are not expressly referenced. Embodiments referenced as “comprising” certain elements are also contemplated as “consisting essentially of” and “consisting of” those elements. When two or more ranges for a particular value are recited, this disclosure contemplates all combinations of the upper and lower bounds of those ranges that are not explicitly recited. For example, recitation of a value of between 1 and 10 or between 2 and 9 also contemplates a value of between 1 and 9 or between 2 and 10.

As used here, the term “film” refers to a layer of material which has a thickness suitable for use in an adhesive application.

### Dry Adhesive Composition

The present disclosure provides a gecko-inspired dry adhesive. According to an aspect disclosed herein, the gecko-inspired dry adhesive can be a surface material such as a film, a layer, or a coating on a surface. The surface material can be based on a polydopamine-substituted silk fibroin (PDA-SF). Generation of PDA-SF is described in WO2021025790A3, incorporated herein by reference in its entirety. Briefly, PDA-SF is created by adding dopamine (CAS number 51-61-6) to a solution of silk fibroin and allowing the dopamine to polymerize in the presence of the silk fibroin over the course of days. To generate the PDA-SF, silk fibroin can be mixed with dopamine in an aqueous solution in a ratio by weight of silk fibroin to dopamine of between 1:2 and 10:1. The mixture of silk fibroin with the dopamine in an aqueous solution can be in a ratio by weight of silk fibroin to dopamine of between 1:1 and 5:1, or between 1.25:1 and 3:1, including but not limited to, at least 1:2, at least 1.5:1, at least 1:1, at least 1.1:1, at least 1.2:1, at least 1.25:1, at least 1.3:1, at least 1.4:1, at least 1.5:1, a least 1.75:1, at least 2:1, at least 3:1, or at least 4:1 and at most 10:1, at most 9:1, at most 8:1, at most 7:1, at most 6:1, at most 5:1, at most 4:1, at most 3:1, at most 2:1, or at most 1:1.

Additionally, and alternatively, a soluble dopamine, or a soluble salt of dopamine such as dopamine hydrochloride (CAS number 62-31-7), can be added to the solution of silk fibroin for polymerization. Silk fibroin can be mixed with the soluble dopamine in an aqueous solution in a ratio by weight of silk fibroin to soluble dopamine of between 1:2 and 10:1. The mixture of silk fibroin with the soluble dopamine in an aqueous solution can be in a ratio by weight of silk fibroin to soluble dopamine of between 1:1 and 5:1, or between 1.25:1 and 3:1, including but not limited to, at least 1:2, at least 1.5:1, at least 1:1, at least 1.1:1, at least 1.2:1, at least 1.25:1, at least 1.3:1, at least 1.4:1, at least 1.5:1, a least 1.75:1, at least 2:1, at least 3:1, or at least 4:1 and at most 10:1, at most 9:1, at most 8:1, at most 7:1, at most 6:1, at most 5:1, at most 4:1, at most 3:1, at most 2:1, or at most 1:1.

During the polymerization with dopamine, soluble dopamine, or any mixture thereof, covalent binding occurs between PDA oligomers and tyrosine residues present in the silk fibroin. The PDA-SF described herein has a molecular structure that is indistinguishable from a comparison PDA-SF structure that is made by mixing comparison silk fibroin with comparison soluble dopamine in a comparison aqueous solution. In other words, the PDA-SF generated from dopamine has the same structure as PDA-SF generated from soluble dopamine when comparable silk fibroin and comparable aqueous solutions (e.g., pH) are used. Without wishing to be bound by any particular theory, it is believed that different methods of making PDA-SF can produce different degrees of crosslinking and association between molecules, so the molecular structure of the PDA-SF may be strongly tied to its method of making. As a result, some of the features described herein are articulated with respect to the method. With that being said, if a PDA-SF with these characteristic features is capable of being produced in some other, different way that is not currently known, then this disclosure is intended to encompass the use of that PDA-SF even though it is not made by the same general method as the comparison.

The PDA used to substitute silk fibroin to make PDA-SF can have any number of dopamine units, for example, 15, 13, 12, 10, 9, or 8 polymeric units or less. As silk fibroin is a protein having an amide backbone and amino acid residues, the PDA-SF can be polydopamine-substituted at one or more target amino acids of the silk fibroin. Target amino acids for substitution by PDA can be selected from cysteine, tyrosine, arginine, lysine, histidine, phenylalanine, proline. More specifically, the PDA-SF can be covalently modified at tyrosine residues by PDA. In Example 1, as shown by GPC measurements, the PDA-SF is covalently modified at one or more tyrosine residues by PDA. Non-limiting descriptions of PDA substitution of silk fibroin are provided in “Bioinspired Biomaterial Composite for All-Water-Based High-Performance Adhesives, Marco Lo Presti, Giorgio Rizzo, Gianluca M. Farinola, Fiorenzo G. Omenetto; 2021, https://doi.org/10.1002/advs.202004786, and WO 2021025790A3, each of which is incorporated herein in its entirety for all purposes, and below in Example 1.

The PDA-SF can have a degree of polydopamine-substitution as measured as a percentage by weight of polydopamine substituents related to the weight of the silk fibroin backbone. For example, if the degree of PDA substitution in PDA-SF is 25%, then the PDA-SF is 25% PDA by weight. The degree of PDA substitution can be between 5% and 50%, between 10% and 40%, or between 25% and 35%.

Plasticizers including but not limited to polyhydric alcohols, acetate esters, phthalate esters, glycerides, or oils can be added to the PDA-SF polymerization solution. Plasticizers can be combined with the PDA-SF in mass ratios ranging between about 0.05 and about 0.9, between about 0.1 and about 0.8, between about 0.2 and about 0.6, or between about 0.3 and about 0.4. In one example, glycerol can be combined with PDA-SF in a mass ratio of between 0.3 to 0.5. Glycerol can be added in the liquid solution after dopamine polymerization, or it can be added together with dopamine prior to the polymerization step as glycerol will not interact with the polymerization.

In some cases, glycerol is present in the gecko-inspired dry adhesive or surface material. The glycerol can be present in a ratio by weight of glycerol to PDA-SF of between 1:10 and 1:1. In some cases, the glycerol is present in a ratio by weight of glycerol to PDA-SF of between 1:5 and 2:3. In some cases, the glycerol is present in a ratio by weight of glycerol to PDA-SF of between 3:10 and 1:2.

### Dry Adhesive Methods

The gecko-inspired dry adhesive or surface material can be affixed to a substrate. Examples of the substrate can include any surface where adhesion is desired, such as planar surfaces, curved surfaces, angled surfaces, or broken surfaces. Suitable substrate materials can include metals, alloys, plastics, organics, fiber-based, ceramics, stone, biological tissues, and the like. In one example, the PDA-SF solution can be cast and dried as a solid film on the substrate to form the surface material.

The surface material can be used for securing an article to the substrate. The surface material can have a surface contact face opposite the substrate. The surface contact face contacts the article for adhering the substrate to the article.

The PDA-SF surface material can be cured with water, metals, or metal salts that activate the adhesive properties. In one specific example, an aqueous solution of Fe³⁺ ions can be used to cure the PDA-SF film and activate the adhesion. The water used for curing can have an acidic pH or a pH in the range of 0.1 to 6.5.

### Surface Structure

According to an aspect disclosed herein, the gecko-inspired dry adhesive can include a gecko-mimicking surface pattern. The surface contact face can be organized in a gecko-mimicking surface pattern to increase the adhesion performance of the gecko-inspired dry adhesive. More specifically, the surface material can include patterned features. The features can be within the size range of 10 nm to 50 μm, where the size can refer the height, width, or length of the feature. Optionally, features can be within the size range of 1 μm to 40 μm, 2 μm to 30 μm, 3 μm to 20 μm, 4 μm to 25 μm, or 5 μm to 15 μm. The patterns can include protrusions or features that are spaced. The features can be elongated, such as columns or prisms. The features can be cuboidal, pyramidal, or hemispherical, or the like. The features can have additional protrusions such as prongs or bristles, or have branched structures. The patterns can include spaced grooves, depressions, indentations, and the like. The features have a range of aspect ratios including, but not limited to, 1:3, 1:2, 1:1, 2:1, and 3:1. The features can be spaced between 1 μm and 25 μm, between 2 μm and 20 μm, between 3 μm and 18 μm, between 4 μm and 16 μm, or between 5 μm and 15 μm.

In one example, the surface contact face can have a plurality of pillars or substantially circular pads. The circular pads can optionally each have a diameter of between 5 μm and 15 μm. The circular pads can optionally each have an edge-to-edge spacing of between 5 μm and 10 μm.

In another example, the gecko-mimicking surface pattern can include a plurality of cylindrical protrusions, each having a substantially circular pad affixed to a distal end. The surface contact face of the surface material in this case includes a plurality of substantially circular pads. In some cases, the circular pads can have larger diameters than the cylindrical protrusions. In other examples, the cylindrical protrusions can have branches or protuberances along the sides.

A method of making the gecko-inspired dry adhesive can include using PDA-SF with glycerol to form the gecko-mimicking surface pattern affixed to a substrate. The forming of the gecko-mimicking surface pattern can include solution casting or molding. The gecko-mimicking surface pattern can be formed directly onto the substrate. Additionally, and alternatively, the gecko-mimicking surface pattern can be formed apart from the substrate and subsequently affixed to the substrate.

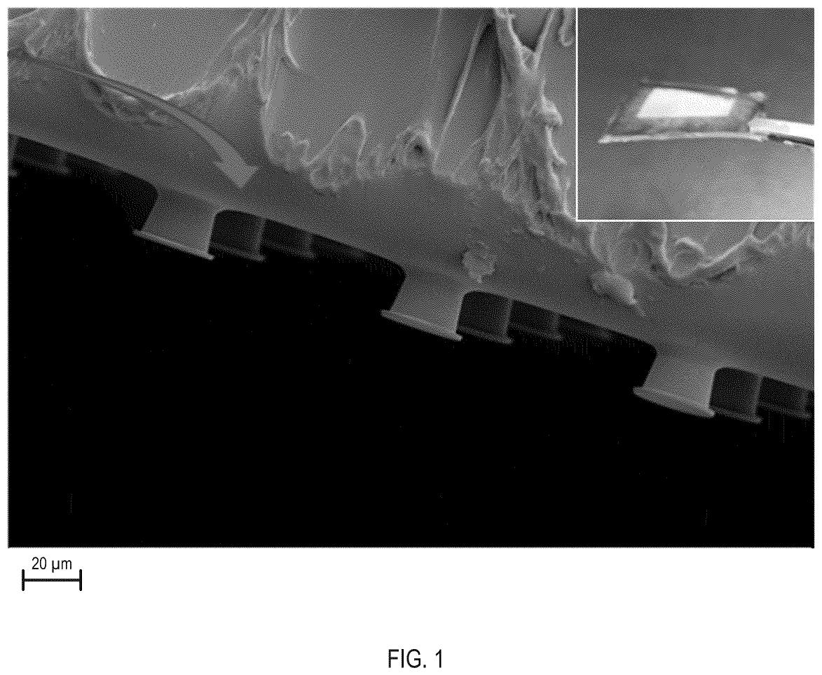

In one example, micropillars 15 m tall and 15 m wide on a silicon wafer were used to create a negative polydimethylsiloxane (PDMS) mold. A PDA-SF-glycerol solution was cast on the negative PDMS mold. In this example, to ensure the correct pillar formation, the PDA-SF-glycerol solution was cast on the mold and was kept in a light vacuum overnight (FIG. 1).

### Comparison Materials and Properties

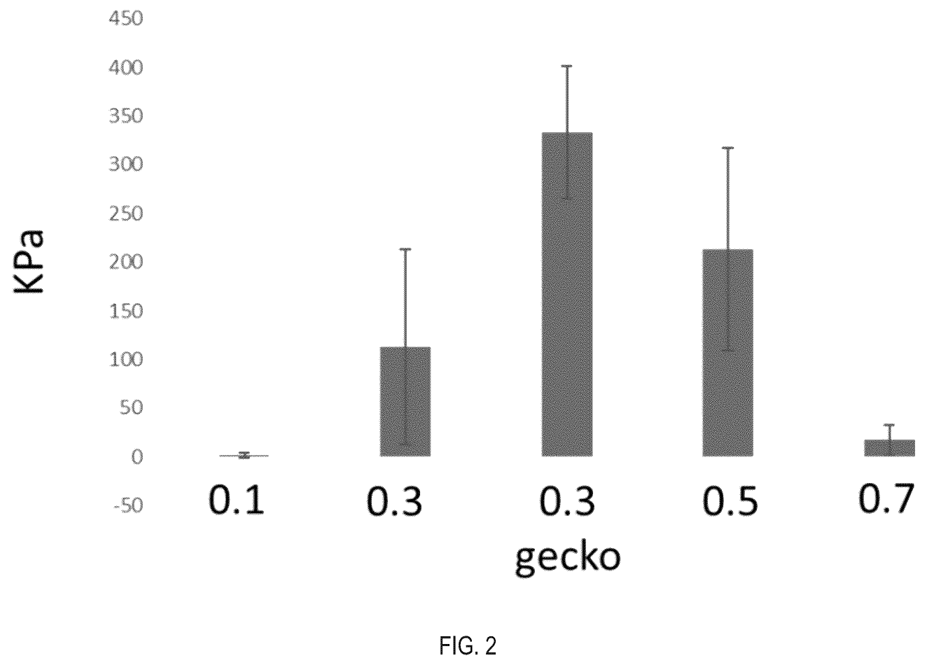

Films formed from the PDA-SF-glycerol compositions described above are self-adhesive and show a pressure-sensitive response. The PDA-SF-glycerol films do not require any additional curing procedures to activate the adhesive properties. Examples of lap shear measurement results are shown in FIG. 2 for a range of glycerol:PDA-SF mass ratios. For this experiment, the PDA-SF-glycerol film is applied on a glass substrate with 50 N of applied pressure for 5 minutes. In this case, the highest adhesive performance is obtained for compositions where the glycerol:PDA-SF mass ratio is between 0.3 to 0.5. For example, for a glycerol:PDA-SF mass ratio of 0.3, the lap shear measurement is about 100 KPa. The adhesion drops substantially outside the mass ratio range of 0.3-0.5, for example when the glycerol:PDA-SF mass ratio is about 0.1 or about 0.7.

The gecko-inspired dry adhesive can have a dry adhesive strength that depends on the surface morphology of the surface material. In other words, the adhesion performance can be enhanced by modifying the film surface with micropatterning. In one example, a PDA-SF-glycerol solution (glycerol:PDA-SF=0.3) was cast on a negative PDMS mold to create a micropattern of micropillars 15 μm tall and 15 μm wide on the PDA-SF-glycerol film. (FIG. 1) The addition of micropatterning increased the adhesion performance to about 325 kPa, or three fold that of the flat or unmodified film that was created using the same glycerol:PDA-SF mass ratio of 0.3. (FIG. 2)

The gecko-inspired dry adhesive can include a gecko-mimicking surface pattern affixed to a substrate and can be used by contacting an article with the gecko-mimicking surface pattern. Compared to a flat-formed surface material with no micropatterning, the gecko-mimicking surface pattern can substantially increase the surface area of the surface contact face between the gecko-mimicking surface pattern and the article, thereby strongly adhering the substrate to the article. The gecko-mimicking surface pattern can further enhance van der Waal's force interactions between the surface contact face and the article to improve adhesion.

### EXAMPLES

### Example 1

A blend composed of Silk fibroin (SF) and dopamine was tested as a curable adhesive both in dry and underwater conditions and the results and technical information are all reported in a published scientific paper.

Briefly, dopamine 200 mM is dissolved in 7% silk solution and it self-polymerizes into polydopamine (PDA) (for 3 days) with the consequent formation of covalent binding between PDA oligomers and silk's tyrosine residues. The solution can be cast and dried as a solid film that can be cured with water or metals (iron is the most effective) that activate its adhesive properties.

Currently we are expanding applications and material formats made out with this composition as well as making improved chemical characterization on the relation between the catechol and the silk protein.

More chemical details on the ratio between dopamine and silk fibroin (and also other proteins) are written in the attached draft (attachment 1) that will be submitted within this month. In the draft there is also a GPC measurement which demonstrates the covalent binding between silk's tyrosine and polydopamine oligomers and their correlation with adhesive strength measured through lap shear testing.

### Silk-Dopamine Gecko Films

To develop a solid-state adhesive formulation, solvent-free and with a long shelf life, we have created free-standing SF-PDA films that can be cured with water or metal ions and used as adhesive.

Recently, we found that by adding glycerol to the composition, the films became self-adhesive, show a pressure-sensitive response and do not require any additional curing procedures. The highest adhesive performance is obtained when glycerol is added between 0.3 to 0.5 mass ratio with silk reaching around 100 KPa in lap-shear measurements.

Briefly, the film is applied on a glass substrate with 50N of applied pressure for 5 minutes (FIG. 1a). The adhesion drops to zero when glycerol is added below 0.1 and above 1 in mass ratio with silk.

We have also tried to increase the adhesion performance by adding micropatterning on the film surface. The patterning was obtained first by etching micropillars 15 μm tall and 15 μm wide on a silicon wafer which was used to create a negative PDMS mold on which the silk-PDA-glycerol solution was cast. To ensure the correct pillar formation, the solution cast on the mold was kept in a light vacuum overnight (FIG. 1b). The addition of micropatterning increased the adhesion performance by three times compared to the flat film.

1. A gecko-inspired dry adhesive comprising a gecko-mimicking surface pattern affixed to a substrate, the gecko-mimicking surface pattern composed of a surface material comprising a polydopamine-substituted silk fibroin.

2. A method of making a gecko-inspired dry adhesive, the method comprising:
a) forming a gecko-mimicking surface pattern affixed to a substrate, the gecko-mimicking surface pattern comprising a polydopamine-substituted silk fibroin, thereby forming the gecko-inspired dry adhesive.

3. The method of claim 2, wherein the forming of step a) includes solution casting or molding the gecko-mimicking surface pattern.

4. The method of claim 2, wherein the forming of step a) includes forming the gecko-mimicking surface pattern directly onto the substrate.

5. The method of claim 2, wherein the forming of step a) includes forming the gecko-mimicking surface pattern apart from the substrate and affixing the gecko-mimicking surface pattern to the substrate.

6. The gecko-inspired dry adhesive of claim 1, the surface material further comprising glycerol.

7. The gecko-inspired dry adhesive of claim 6, wherein the glycerol is present in the surface material in a ratio by weight of glycerol to polydopamine-substituted silk fibroin of between 1:10 and 1:1.

8. (canceled)

9. (canceled)

10. The gecko-inspired dry adhesive of claim 1, wherein the gecko-mimicking surface pattern comprises a surface contact face comprising a plurality of substantially circular pads, wherein the plurality of substantially circular pads optionally each have a diameter of between 5 μm and 15 μm, wherein the plurality of substantially circular pads optionally each have an edge-to-edge spacing of between 5 μm and 10 μm.

11. The gecko-inspired dry adhesive of claim 1, wherein gecko-mimicking surface pattern comprises a plurality of substantially cylindrical protrusions, wherein the plurality of substantially cylindrical protrusions each have a diameter of between 5 μm and 15 μm, wherein the plurality of substantially cylindrical protrusions each have an edge-to-edge spacing of between 5 μm and 10 μm.

12. The gecko-inspired dry adhesive of claim 1, wherein the gecko-mimicking surface pattern comprises a plurality of cylindrical protrusions, each having a substantially circular pad affixed to a distal end, thereby collectively providing a surface contact face comprising a plurality of substantially circular pads.

13. The gecko-inspired dry adhesive of claim 1, wherein the gecko-inspired dry adhesive has a dry adhesive strength that is greater than a first comparison dry adhesive strength, wherein the first comparison dry adhesive strength is from a first comparison gecko-inspired dry adhesive that replaces the polydopamine-substituted silk fibroin with an unmodified silk fibroin and is otherwise identical to the gecko-inspired dry adhesive, wherein the dry adhesive strength is greater than the first comparison dry adhesive strength.

14. The gecko-inspired dry adhesive of claim 1, wherein the gecko-inspired dry adhesive has a dry adhesive strength that is greater than a second comparison dry adhesive strength, wherein the second comparison dry adhesive strength is from a comparison polydopamine-substituted silk fibroin film that has a flat surface and lacks the gecko-mimicking surface pattern.

15. The gecko-inspired dry adhesive of claim 1, wherein the polydopamine-substituted silk fibroin has a degree of polydopamine-substitution of between 5% and 50%, wherein the degree of polydopamine-substitution is measured as a percentage by weight of polydopamine substituents related to the weight of the silk fibroin.

16. The gecko-inspired dry adhesive of claim 1, wherein the polydopamine-substituted silk fibroin is polydopamine-substituted at one or more target amino acids, wherein the one or more target amino acids are selected from the group consisting of cysteine, tyrosine, arginine, lysine, histidine, phenylalanine, proline, and combinations thereof.

17. The gecko-inspired dry adhesive of claim 1, wherein the polydopamine-substituted silk fibroin is polydopamine-substituted at one or more tyrosines.

18. The gecko-inspired dry adhesive of claim 1, wherein the polydopamine-substituted silk fibroin is substituted with polydopamine having 15, polymeric units or less.

19. The gecko-inspired dry adhesive of claim 1, wherein the polydopamine-substituted silk fibroin is made by mixing silk fibroin with soluble dopamine in an aqueous solution.

20. The gecko-inspired dry adhesive of claim 1, wherein the polydopamine-substituted silk fibroin has a molecular structure that is indistinguishable from a comparison molecular structure that is made by mixing comparison silk fibroin with comparison soluble dopamine in a comparison aqueous solution.

21. The gecko-inspired dry adhesive of claim 19, wherein the soluble dopamine is dopamine hydrochloride.

22. (canceled)

23. (canceled)

24. A method of using the gecko-inspired dry adhesive of claim 1, the method comprising: contacting an article with the gecko-mimicking surface pattern, thereby adhering the substrate to the article.
